(19) United States
(12) Patent Application Publication
(10) Pub. No.: US 2009/0217242 A1
(43) Pub. Date: Aug. 27, 2009

(54) LEARNING SOFTWARE PROGRAM TO WEB-BASED FILE CONVERTER

(75) Inventor: Frederick Z. Banks, Wentzville, MO (US)

Correspondence Address: LEE & HAYES, PLLC, 601 W. RIVERSIDE AVENUE, SUITE 1400, SPOKANE, WA, 99201, US

(73) Assignee: THE BOEING COMPANY, Chicago, IL (US)

(21) Appl. No.: 12/037,217

(22) Filed: Feb. 26, 2008

(51) Int. Cl. G06F 9/45; G06F 9/44

(52) U.S. Cl. 717/115; 717/136

(57) ABSTRACT

Techniques for providing an interactive software based learning system file to web-based file converter are disclosed. In one embodiment, a method includes analyzing a learning software file to locate data stored in at least one of an internal database or an external database, exporting the data to a XML file, locating elements in the XML file, and outputting the located elements to a web-based file. Additional embodiments may include acquiring a learning software file, converting the learning software file to an XML file, analyzing the XML file to identify at least one parent element, creating web-based code for the at least one parent element, and outputting the web-based code for display to a user.

### TECHNICAL FIELD

The present disclosure teaches techniques of converting file types, and more specifically, to converting a learning software programs to a web-based file.

### BACKGROUND

Many people use interactive software based learning systems to remain current on a variety of topics or to learn about new topics or obtain skills. Some interactive software based learning systems are independent stand-along programs that advantageously allow a user to execute the software without first opening associated application software. Generally speaking, interactive learning system software is multimedia content creation software that enables a user to create an interactive lesson for viewing and interaction by other users (e.g., students, peers, etc.). The multimedia content may include text, images, audio, video, and special effects, such as slide transitions, test scoring, and other interactive or visual effects. Once a lesson is created, the software may be compiled to create a stand-alone executable file for distribution to users. In addition, some interactive learning system software files may be accessed over a network, such as the Internet, typically using a special program web-enabled application.

Although many multimedia content creation tools exist, particular software titles may be widely used for creating lessons and other files. One reason for a particular software's popularity may be due to its early entrance to market, thus resulting in widespread adoption before other competitor offerings may arrive in the marketplace. Over time, large volumes of files are created using the particular software. Many lessons may be in existence and include regular use. These files rely on current versions of the particular software for revisions, edits, or other maintenance.

### SUMMARY

Embodiments of techniques for providing an interactive software based learning system file to web-based file converter are disclosed. In one embodiment, a method includes analyzing an interactive software based learning system file to locate data stored in at least one of an internal database or an external database, exporting the data to a XML file, locating elements in the XML file, and outputting the located elements to a web-based file. Additional embodiments may include acquiring a learning software file, converting the file to an XML file, analyzing the XML file to identify at least one parent element, creating HTML code for the at least one parent element, and outputting the HTML code for display to a user.

In a further embodiment, a method includes acquiring an XML file including a parent element associated with a plurality of child elements. For each child of the parent element, the method includes: determining coordinates for the child, the determined coordinates being updated to relational coordinates, identifying attributes of the child, and identifying attribute values of the child. For each parent element, the method includes: generating web-based code from the plurality of child elements including the global coordinates, identified attributes, and identified attribute values and outputting a web-based file including the converted parent elements.

The features, functions, and advantages can be achieved independently in various embodiments of the present disclosure or may be combined in yet other embodiments.

### BRIEF DESCRIPTION OF THE DRAWINGS

Embodiments of techniques in accordance with the present disclosure are described in detail below with reference to the following drawings.

FIG. 1 is an illustrative system for implementing an interactive software based learning system file to web-based file converter in accordance with an embodiment of the disclosure;

FIG. 2 shows a flow diagram of an illustrative process of converting an interactive software based learning system file to a web-based file in accordance with another embodiment of the disclosure;

FIG. 3 shows a flow diagram of an illustrative process of creating XML files from an interactive software based learning system file in accordance with yet another embodiment of the disclosure; and

FIG. 4 shows a flow diagram of an illustrative process of analyzing an XML file to create a reordered web-based file in accordance with an embodiment of the disclosure.

### DETAILED DESCRIPTION

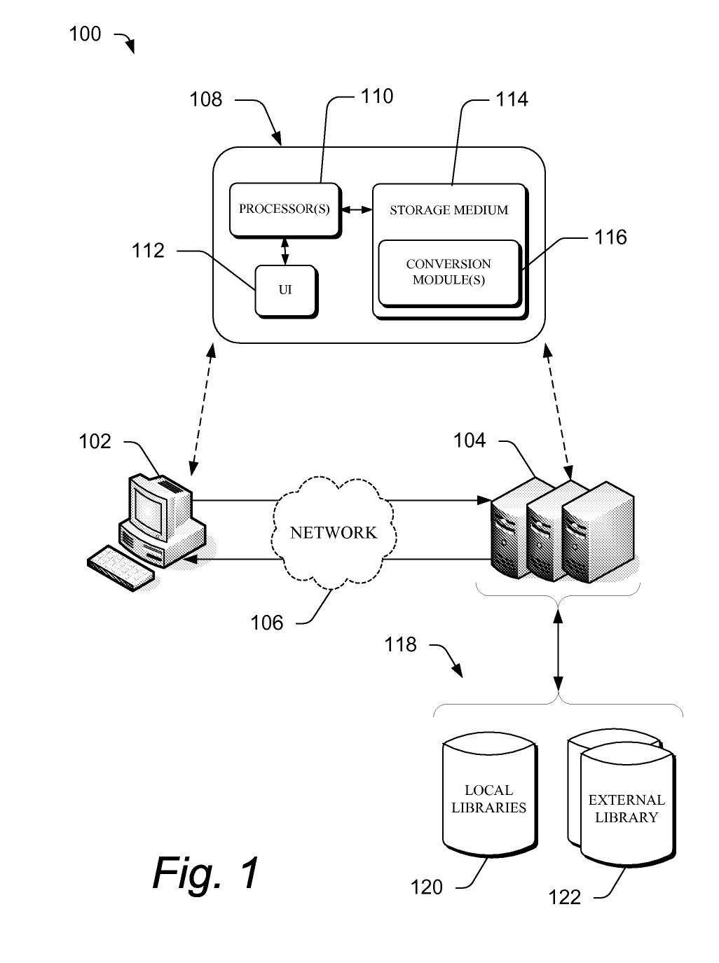

Techniques for providing an interactive software based learning system (hereinafter “learning software”) file to web-based file converter are described herein. Many specific details of certain embodiments of the disclosure are set forth in the following description and in FIGS. 1 through 4 to provide a thorough understanding of such embodiments. One skilled in the art, however, will understand that the present disclosure may have additional embodiments, or that the present disclosure may be practiced without several of the details described in the following description.

FIG. 1 is an illustrative environment 100 for implementing a learning software file to web-based file converter in accordance with an embodiment of the disclosure. The environment may include a computing device 102 such as a desktop computer, laptop, PDA (personal digital assistant), mobile telephone (including smart phones and pocket pcs) or other computing device. The computing device 102 contains modules to perform tasks to facilitate converting learning software files to web-based files, such as HTML files. As shown in the environment 100, the computing device 102 may be in communication with one or more servers 104 via a network 106. In one or more embodiments, the servers 104 may be arranged as a server farm or in other suitable arrangements to enable efficient processing of modules described herein.

The network 106 may be wired or wireless and provide connectivity between the computing device 102 and the servers 104. Wireless environments may include cellular, PCS, WIFI, Ultrawideband, Bluetooth, satellite transmission, and other equivalent wireless technologies. Although FIG. 1 depicts only one computing device 102, multiple computing devices may be used for in accordance with embodiments of the present data conversion disclosure.

The computing device 102 and/or the servers 104 may include a number of components 108. Although each of the computing device 102 and the servers 104 may include separate instances of the components 108, FIG. 1 only includes one representation of the components 108 for illustrative purposes. The components 108 may include one or more processors 110 that are coupled to instances of a user interface (UI) 112. The UI 112 represents any devices and related drivers that enable the computing device 102 and/or the servers 104 to receive input from a user or other system, and to provide output to the user or other system. Thus, to receive inputs, the UI 112 may include keyboards or keypads, mouse devices, touch screens, microphones, speech recognition packages, imaging systems, or the like. Similarly, to provide outputs, the UI 112 may include speakers, display screens, printing mechanisms, or the like.

The computing device 102 and/or the servers 104 may include one or more instances of a computer-readable storage medium 114 that are addressable by the processor 110. As such, the processor 110 may read data or executable instructions from, or store data to, the storage medium 114. The storage medium 114 may contain a conversion module 116, which may be implemented as one or more software modules that, when loaded into the processor 110 and executed, cause the computing device 102 and/or the servers 104 to perform any of the functions described herein, such as to convert a learning software file to a web-based file in accordance with embodiments of the present disclosure. Additionally, the storage medium 114 may contain implementations of any of the various software modules described herein.

In some embodiments, the servers 104 may be in communication with databases 118, such as local libraries 120 or one or more external library 122. The databases may store files, including images, audio files, video files, text, or other information related to a learning software file or a web-based file.

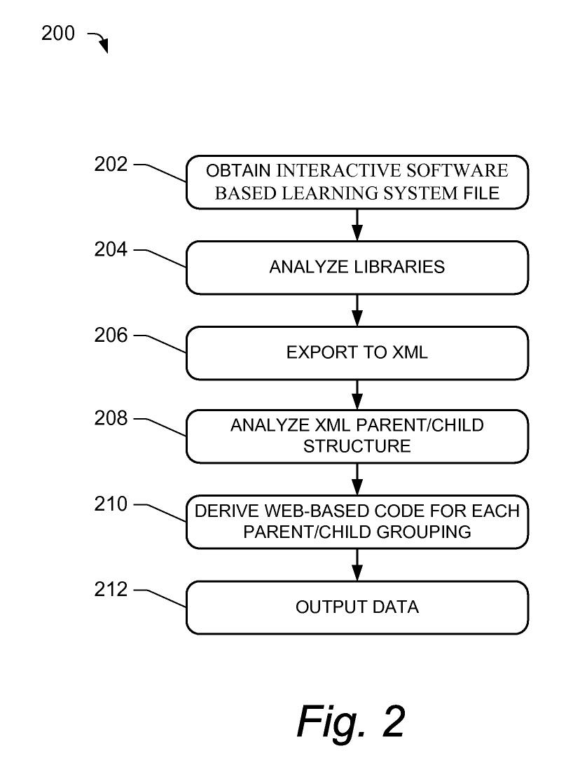

FIG. 2 shows a flow diagram of an illustrative process 200 of converting a learning software file to a web-based file in accordance with another embodiment of the disclosure. Further, the description of process 200 may refer to components of the system described in FIG. 1. The process 200 may begin by obtaining a learning software file (program) at 202. For example, an existing learning software file may be an interactive program used as a lesson, presentation, or for other purposes, and may include elements such as text, images, audio, video, and the like. In some embodiments, the learning software file may be generated by Authorware® published by the Adobe Systems Inc., of San Jose, Calif. A person may desire to update the interactive program by modifying elements in the program.

In accordance with embodiments of the disclosure, the learning software file may be analyzed to identify libraries of information used in the program at 204, such as libraries in databases 118. For example, an interactive program may access information from a plurality of libraries, both internal (e.g., local libraries 120) and external (e.g., external libraries 122) to the learning software file. One such library may provide text, reference data, or images, while another library may provide audio and video files used by the learning software file. At 206, the learning software file is exported to XML (extensible markup language) using an “Export to XML” feature provided in learning software. The process 200 creates an XML file at 206 which may be further analyzed in the process.

At 208, the XML file is analyzed to determine parent elements and child elements. For example, a parent element may be a display page that contains a plurality of child elements, such as text, styles, videos, images, or other data. Typically, a parent element includes a plurality of child elements, however, some parent elements may not include a child element. During the analysis at 208, each parent/child grouping is identified.

At 210, web-based code, such as HTML (hypertext markup language), may be derived for each parent/child grouping. For example, a HTML page is created for each parent element and includes the data for the child elements. In other embodiments, the parent elements and child elements may be converted into other readable formats that enable easy access to an editor. For example, the XML file with a parent/child structure may be converted to a Microsoft® PowerPoint®, which is published by the Microsoft Corporation of Redmond, Wash. In some embodiments, a hierarchy of the learning software file may be flattened as it is converted to an XML file and then to an HTML file. Finally, at 212, the web-based file is outputted. In some embodiments, a HTML file may be posted on a web page for use via a network such as a LAN (local area network) or WAN (wide area network), or the Internet.

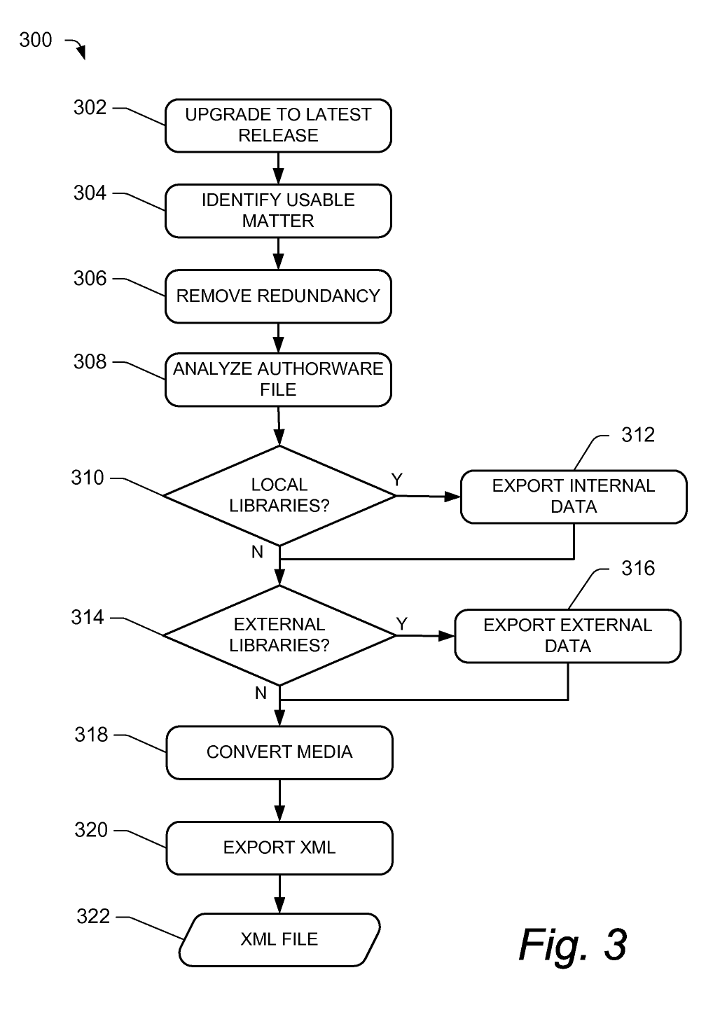

FIG. 3 shows a flow diagram of an illustrative process 300 of creating XML files from a learning software file in accordance with yet another embodiment of the disclosure. The process 300 is illustrated as a collection of blocks in a logical flow diagram, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 300, shall be interpreted accordingly. For discussion purposes, the process 300 is described with reference to the environment 100 of FIG. 1.

At 302, a previous version of the learning software may be upgraded to a most recent version of the learning software, which may include an “Export to XML” feature. In addition or alternatively, the most recent version of the learning software may include other desirable enhancements which may provide a creation of a more desirable web-based file output. At 304, usable matter is identified in the learning software file. In some embodiments, a learning software file may include elements (e.g., text, images, audio, video, etc.) and calculations, modules, or other features that manipulate the elements. The usable matter includes elements which may be extracted from the learning software file. An illustrative learning software file may be a program that includes a teaching portion that teaches a user a new skill and a quiz portion that generates a quiz to test the user's understanding of the material. In such a program, the elements used in the teaching portion, including the text, images, etc., along with transitions and other effects may be usable matter. In addition, the quiz questions (text, images, etc.) may be usable matter. However, the logic used to select quiz questions (e.g., randomizer, etc.) and grade the quiz answers may not be usable subject matter.

In accordance with one or more embodiments, the process 300 may analyze the identified subject matter for redundancies and remove the redundancies at 306. For example, a block of text may be used in multiple places in an interactive program and be stored more than once (i.e., redundancy) in a library. At 308, the learning software file is analyzed to determine informational relationships associated with the file. For example, the interactive program may link to internal (local) libraries and/or external libraries when the program is operated by a user.

At a decision 310, the process determines if local libraries are used in the interactive program. If local libraries are used, the process may proceed to 312 where data from the local libraries is exported to one or more data file. For example, the interactive program may call a single internal library during execution of the program. The single library may be exported to a database at 312 for further processing in accordance with embodiments of the disclosure.

A second decision 314 determines if external libraries are used in the interactive program. External libraries may include databases such as a Microsoft® Access® database, an Oracle® database, or other databases which maintain information that may be accessible from the learning software file. If external libraries are used, the process may proceed to 316 where data from the external libraries is exported to one or more data file. For example, the interactive program may call a database that includes a lookup table of data. The lookup table may be exported to a file (or database) at 316 for further processing in accordance with embodiments of the disclosure.

At 318, the media included in the learning software file, such as images, audio, video, or other media is converted to predetermined file formats. The predetermined file formats are selected based on factors such as the intended use of the XML file or aspects of the resulting file format. In some embodiments, the predetermined file formats may be selected based on a format compression ratio. For example, image files originally formatted in .bmp (bitmap format) may be converted to the more widely used and compressed .jpg (jpeg) format. In addition, other files may be converted from formats such as .wav to formats such as .fla and or .swf (associated with Adobe Flash®). Other file format conversions are contemplated which advantageously improve usability, storage, or are advantageous for other attributes when used with a converted learning software interactive program.

At 320, the learning software file is exported to XML using the “Export to XML” feature. Thus, an XML file is created at 320 which includes at least a portion of the subject matter identified from 304. At 322, the XML file is outputted which includes links to any exported internal libraries at 312 and/or external libraries at 316. In one or more embodiments, the files generated from exporting internal libraries at 312, external libraries at 314, and/or media files at 318 may be renamed during the process 300. For example, the process 300 may implement a file naming convention which organizes files based on factors such as the interactive program name, storage location, usage, or other factors.

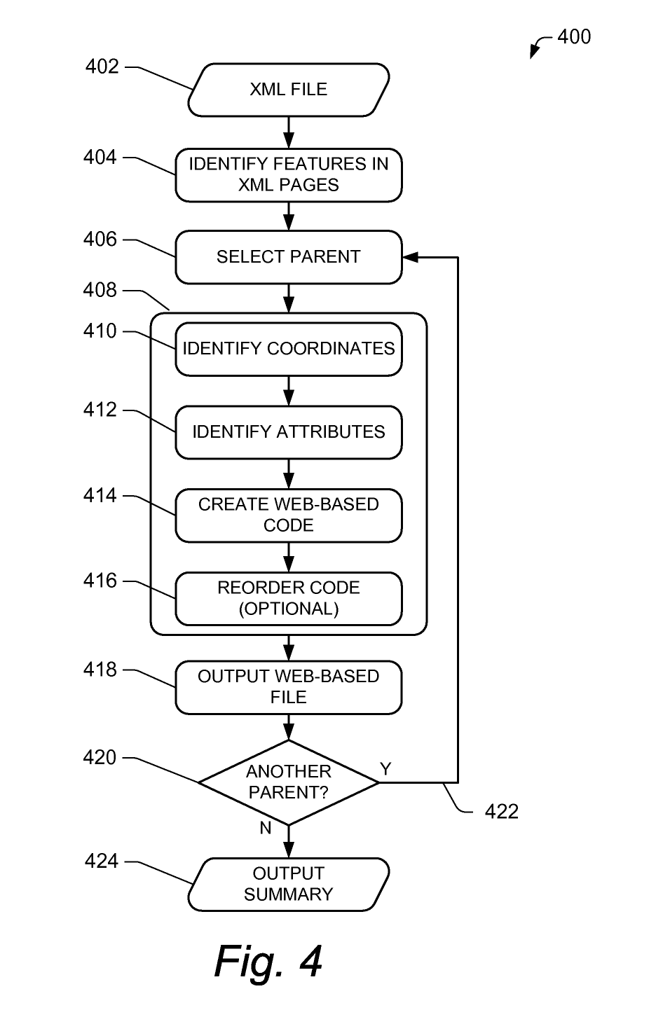

FIG. 4 shows a flow diagram of an illustrative process 400 of analyzing an XML file to create a reordered web-based file in accordance with an embodiment of the disclosure. The process may begin by acquiring a XML file at 402, such as the XML file created from process 300 at 322. At 404, elements in the XML file are identified. For example, parent elements (sub-icons) are identified that may include associated child elements. In addition or alternatively, converted media may be identified at 404, such as the converted media from 318. For example, the converted media may be identified as associated with the XML page at 404, including without limitation identifying renamed media files, external database references, or internal database references.

At 406, a parent element is selected for further processing. For example, a number of elements may be identified at 404, which include a first element parent, second parent element, and so forth. Each parent element may include one or more associated child elements. A series of sub-processes 408 are included after the selection of the parent at 406. Next, the parent element, and any associated child elements, may be processed by one or more of the sub-process 408. The process identifies any coordinates associated with the elements at 410. If coordinates are identified, the coordinates may be revised with new global coordinates that may be associated with the parent element. The new global coordinates may be loaded into variables for further processing of the parent elements.

In accordance with one or more embodiments, element attributes are identified at 412. More specifically, element attributes and element values may be identified for each child element. For example, the element attributes may include: sound, .rtf (rich text format), poly (polygon), line, rect (rectangle), roundRect (round rectangle), image, points, text, width, height, filename, storage, format, and/or attributes. Generally speaking, element attributes may include text, graphics and/or functionality in an interactive program such as transitions, fading, commands, and other similar features. In addition, any element values associated with the element attributes are identified at 412. For example, an element value for element attributes such as a fading effect may include a time value for the fade effect (e.g., 3 seconds). Other element values may include color, size, or other values.

At 414, the process creates web-based file code of the attributes. In some embodiments, the web-based file code is HTML code. In addition or alternatively, JavaScript® routines may be created and used to implement non-standard effects such as non-standard graphical effects, from a web-based file. For example, an element attribute of a fading effect may be implemented using a JavaScript routine which is eventually called by the web-based code. The web-based code may include information stored, converted, or referenced in the original learning software file (as described above). For example, an image may include an image extracted name and may include a converted image file as discussed at 318 in FIG. 3. A .rtf file may extract text, extract color of the text or other properties of the text, and identify variables associated with the .rtf file. Polygons may be converted to the web-based code by adding an associated JavaScript library (if necessary), extracting color or other properties, converting coordinates (if necessary), and converting to JavaScript routines. Similar sub-process may be used for lines, rectangles, ovals (circle), and round rectangles.

At 416, the web-based code may be optionally reordered to improve the flow of the code, remove logical inconsistencies, or for other reasons. At 418, the web-based file is outputted to create a reusable object. The web-based file includes the content from parent element and any associated child elements. The web-based file may include links to any exported internal libraries at 312 and/or external libraries at 316. In accordance with one or more embodiments, the output file is a HTML file. The HTML file may be uploaded to a server, such as server 104, for publication on a network.

At 420 a determination is made to whether another parent element exists and requires further processing. If another parent element is identified, the process continues along route 422 to selecting the parent element at 406, which may include progression through the sub-processes 408. Finally, a summary file is output at 424. For example, a summary file may include warning such as files not found and processes that are incomplete. In addition or alternatively, the summary file may include a notification that the processes, such as the process 300 and/or the process 400 have successfully been completed.

While preferred and alternate embodiments of the disclosure have been illustrated and described, as noted above, many changes can be made without departing from the spirit and scope of the disclosure. Accordingly, the scope of the disclosure is not limited by the disclosure of these preferred and alternate embodiments. Instead, the disclosure should be determined entirely by reference to the claims that follow.

What is claimed is:

1. A method, comprising:
acquiring an interactive software based learning system (learning software) file;
converting the learning software file to an XML file;
identifying at least one parent element in the XML file;
creating HTML code for the at least one parent element; and
outputting the HTML code for display to a user.

2. The method of claim 1, further comprising converting at least a portion of data in an external database to the XML file, the external database in communication with the learning software file.

3. The method of claim 1, wherein converting the learning software file includes converting at least one of a text file, an image file, an audio file, or a video file to a new file format, the new file format configured to be accessible by the HTML code.

4. The method of claim 1, wherein the at least one parent element includes a plurality of child elements associated with the parent element.

5. The method of claim 4, wherein each child element has at least one attribute, the attribute including an attribute value.

6. The method of claim 4, wherein each child includes coordinates to locate the child element with the parent element.

7. One or more computer readable media comprising computer-executable instructions that, when executed by a computer, perform acts comprising:
analyzing an learning software file to locate data stored in at least one of an internal database or an external database;
exporting the located data to a XML file;
locating elements in the XML file, the elements originating from the learning software file; and
outputting the located elements to a web-based file.

8. One or more computer readable media as in claim 7, further comprising generating JavaScript® routines to implement non-standard features located in the XML file.

9. One or more computer readable media as in claim 8, wherein the JavaScript® routines are called by the web-based file, and wherein the web-based file is an HTML file.

10. One or more computer readable media as in claim 7, wherein the learning software is created by Authorware®, and wherein exporting the data to a XML file includes exporting data using Authorware®, version 7.0 or later.

11. One or more computer readable media as in claim 7, wherein the located elements include at least one parent element associated with a plurality of child elements, and a hierarchical relationship of the parent element and child elements are flattened during the output to the web-based file.

12. One or more computer readable media as in claim 7, further comprising reordering the located elements in the web-based file.

13. One or more computer readable media as in claim 7, wherein the web-based file is an HTML file.

14. A method, comprising:
acquiring an XML file including a parent element associated with a plurality of child elements;
for each child of the parent element:
determining coordinates for the child, the determined coordinates being updated to global coordinates associated with the parent element;
identifying attributes of the child; and
identifying attribute values of the child;
for each parent element:
generating web-based code from the plurality of child elements including the global coordinates, identified attributes, and identified attribute values; and
outputting a web-based file including the converted parent elements.

15. The method of claim 14, wherein the XML file is acquired from an output from an interactive software based learning system.

16. The method of claim 14, wherein the web-based file is an HTML file.

17. The method of claim 14, wherein identifying attributes of the child further includes creating JavaScript® routines to implement the attributes including the attribute values.

18. The method of claim 14, wherein the attributes include at least one of sound, rich text format (rtf), or a predefined graphical image.

19. The method of claim 14, wherein the attribute values include at least one of color, size, or time.

20. The method of claim 14, wherein the acquired XML file having the parent element associated with the plurality of child elements includes a hierarchical structure and the outputted web-based file includes a flat structure.
